(19) United States
(12) Patent Application Publication
(10) Pub. No.: US 2026/0001968 A1
(43) Pub. Date: Jan. 1, 2026

(54) METHOD FOR PREPARING HEAVY-DUTY TIRE WITH NATURAL RUBBER MODIFIED BY GRAPHENE/CARBON BLACKS VARYING IN PARTICLE SIZE SYNERGIZED WITH VULCANIZATION SYSTEM

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Guizhe ZHAO, Taiyuan (CN)

(21) Appl. No.: 19/317,857

(22) Filed: Sep. 3, 2025

Related U.S. Application Data
(63) Continuation of application No. PCT/CN2023/107122, filed on Jul. 13, 2023.

(30) Foreign Application Priority Data
Jun. 30, 2023 (CN) 202310787866.0

(51) Int. Cl. C08C 2/00; B60C 1/00

(52) U.S. Cl. CPC C08C 2/00; B60C 1/00; B60C 2200/06

(57) ABSTRACT

A method for preparing a heavy-duty tire with a natural rubber (NR) modified by graphene/carbon blacks varying in particle size synergized with a vulcanization system is provided. Carbon blacks varying in particle size are subjected to surface modification to obtain an graphene oxide/carbon blacks varying in particle size aqueous dispersion. Subsequently, a graphene oxide/carbon blacks varying in particle size modified NR masterbatch is prepared using an aqueous-phase synergistic aggregating precipitating process. Finally, a natural rubber heavy-duty tire is prepared from graphene/carbon blacks varying in particle size synergistically vulcanized modified natural rubber through a molding process. Compounding of graphene with the carbon blacks varying in particle size is utilized to improve dispersion of reinforcing fillers within the rubber matrix. Adjustment of a ratio of a vulcanizing agent to an accelerator is utilized to regulate a cross-linked network structure of the rubber.

### CROSS-REFERENCE TO RELATED APPLICATIONS

This application is a continuation of International Patent Application No. PCT/CN2023/107122, filed on Jul. 13, 2023, which claims the benefit of priority from Chinese Patent Application No. 202310787866.0, filed on Jun. 30, 2023. The content of the aforementioned application, including any intervening amendments made thereto, is incorporated herein by reference in its entirety.

### TECHNICAL FIELD

This application relates to natural rubber and tires, and more particularly to a method for preparing a heavy-duty tire with a natural rubber modified by graphene/carbon blacks varying in particle size synergized with a vulcanization system.

### BACKGROUND

Natural rubber (NR) possesses a unique strain-induced crystallization capability that imparts it with excellent mechanical properties, abrasion resistance, and high elasticity, etc. As a critically important key material, NR has been widely used in fields such as heavy-duty solid tires and tank road wheel tires. It is well known that during operation, heavy-duty tires are subjected to high-intensity impact and cyclic loading, consequently imposing increasingly stringent requirements on the performance of the materials forming them. However, due to its excessively low hardness, NR undergoes substantial deformation under external force. On one hand, this prevents it from supporting heavy engineering equipment. On the other hand, it is highly prone to generating microcracks, leading to failure and thereby reducing service life. Furthermore, the hysteresis phenomenon arising from NR's inherent viscoelasticity causes it to convert mechanical energy into internal heat when subjected to dynamic stress, resulting in degradation of NR's performance and ultimate failure.

Graphene is a novel material consisting of a single-layer two-dimensional (2D) honeycomb lattice structure formed by compact packing of sp2 hybridized carbon atoms. It has excellent optical, electrical, and mechanical properties, holding vast application prospects in materials, micro-nano processing, energy, biomedicine, and drug delivery, and is considered as a revolutionary material in the future. Graphene oxide (GO) is a 2D material with multiple oxygen-containing functional groups obtained by oxidizing graphite by physical or chemical means. The exceptional mechanical strength, electrical conductivity, and thermal conductivity of the graphene and its derivatives thereof have led to their widespread use in rubber reinforcement and modification. This enables the production of rubber products with enhanced mechanical strength, toughness, and thermal conductivity.

As a crucial reinforcing filler for NR, carbon black (CB), due to its surface containing a large number of functional groups and its branched aggregate morphology, can entangle and adsorb with other fillers and rubber molecular chains. Therefore, adding carbon black to the rubber matrix can significantly improve hardness, abrasion resistance, mechanical strength, etc. The three factors by which carbon black influences the mechanical properties of rubber are particle size, degree of surface structure, and surface activity. The particle size of carbon black is determined by its production process. Smaller particle size results in a larger specific surface area, providing more contact and adsorption sites with rubber molecular chains, and consequently, a better reinforcing effect on the rubber. The degree of structure characterizes the degree of development of the branched aggregate structure of carbon black. The more developed the branched structure of the carbon black aggregate, the higher the degree of structure. N110 carbon black has a small particle size and provides an excellent reinforcing effect. N330 carbon black exhibits low heat generation value and excellent abrasion resistance. N660 carbon black disperses easily and generates low heat. N765 carbon black has a large particle size and excellent processing performance. Therefore, these types of carbon black have been widely used for rubber reinforcement. However, although adding a large amount of a single carbon black as the reinforcing filler can effectively improve the hardness of rubber composites, it simultaneously leads to the generation of substantial heat when subjected to dynamic stress, which can readily cause aging and failure of rubber products. Additionally, the addition of large amounts of a single reinforcing filler increases the cost of the composites, further limiting the application of NR composites in heavy-duty tires.

Vulcanization refers to a process in which the rubber is transformed from linear macromolecules into a three-dimensional (3D) network structure in the presence of crosslinking agents such as vulcanizing agents and accelerators under specific temperature and pressure. The most traditional vulcanizing agent is sulfur. Currently, sulfur remains the most commonly used vulcanizing agent in the rubber products industry. Based on the dosage of sulfur and accelerator, the sulfur vulcanization systems are classified into conventional vulcanization (CV) system, semi-efficient vulcanization (SEV) system, and efficient vulcanization (EV) system, each having distinct characteristics. The CV system is also known as the traditional vulcanization system, which employs sulfur in the range of 2-3 parts by weight, used with appropriate amounts of accelerator and activator. In the SEV system, the dosage of the sulfur is less than that in the CV system, or sulfur donors are used to replace part of the sulfur. Generally, the dosage of the sulfur is 0.8-1.5 parts by weight, and the total amount of sulfur donors and accelerators is above 1-1.5 parts by weight. The EV system employs the least sulfur, which typically uses 0.3-0.5 parts by weight of the sulfur and 3-5 parts by weight of the accelerator, or employs no sulfur at all, and utilizes high dosages of efficient sulfur carriers as the vulcanizing agent combined with the accelerator to enhance the activity of the vulcanization system. Rubber vulcanized by the CV system primarily contains polysulfide crosslinks, with very few monosulfide and disulfide crosslinks. Rubber vulcanized by the SEV system contains approximately equal proportions of polysulfide and low-sulfur crosslinks. Rubber vulcanized by the EV system predominantly contains monosulfide or disulfide crosslinks, accounting for over 90%. The crosslinked network of rubber composites including crosslinking density and crosslinking structure is a decisive factor for the service performance and fatigue life of the rubber composites. In recent years, numerous studies have employed different vulcanization systems to regulate crosslinking density and crosslinking structure, thereby obtaining vulcanizates and products with varied performance characteristics.

### SUMMARY

In order to address the problem that the addition of large amounts of a single reinforcing filler limits the application of natural rubber (NR) composites in the field of heavy-duty tires, the present disclosure provides a method for preparing a heavy-duty tire with a natural rubber modified by graphene/carbon blacks varying in particle size. This application achieves enhancement of service life of NR and heavy-duty tires formed therefrom through two approaches. One of the two approaches is to compound graphene with carbon blacks varying in particle size to prepare a modified NR composite for long-life heavy-duty tires, so as to improve the dispersion of reinforcing fillers within the rubber matrix. This concurrently increases the hardness and mechanical properties of the rubber while imparting the formed tire with a lower compression heat generation value during motion, thereby mitigating aging failure of the heavy-duty tire and extending service life of the heavy-duty tire. The other of the two approaches is to regulate a crosslinked network structure of the rubber by adjusting a ratio of vulcanizing agent to accelerator, thereby imparting superior mechanical properties on the basis of improving the heat generation and hardness of the rubber, thus further enhancing the service life of the NR heavy-duty tire. Therefore, the present disclosure provides a method for preparing a heavy-duty tire with a natural rubber modified by graphene/carbon blacks varying in particle size synergized with a vulcanization system. Firstly, a graphene oxide (GO)/carbon blacks varying in particle size modified NR masterbatch is prepared through an aqueous-phase synergistic aggregating precipitating process. Then, a graphene/carbon blacks varying in particle size synergistically modified NR compound is prepared by means of mechanical blending. Finally, the heavy-duty tire is prepared from the graphene/carbon blacks varying in particle size and a vulcanization system modified NR through a molding process.

Technical solutions of the present disclosure are described as follows.

This application provides a method for preparing a heavy-duty tire with a natural rubber (NR) modified by graphene/carbon blacks varying in particle size synergized with a vulcanization system, comprising:
(1) sequentially adding water, a disodium methylene bisnaphthalene sulphonate, a sodium alkylnaphthalene sulfonate, KOH, and a casein into a mixer under stirring for dissolution; and after complete dissolution, sequentially adding a quartz sand and carbon blacks varying in particle size into the mixer followed by stirring at a first preset speed for a first preset time to obtain a dispersion of surface-treated carbon blacks varying in particle size;
   wherein a weight ratio of the water to the disodium methylene bisnaphthalene sulphonate to the sodium alkylnaphthalene sulfonate to the KOH to the casein to the quartz sand to the carbon blacks is 720:1:0.5:1.5:3:150:80; the carbon blacks comprise N330 carbon black, N110 carbon black, N660 carbon black, and N765 carbon black; and a weight ratio of the N330 carbon black to the N110 carbon black to the N660 carbon black to the N765 carbon black is 3:0-1:0-1:0-1, wherein the N110 carbon black, the N660 carbon black, and the N765 carbon black are not simultaneously 0;
(2) subjecting a graphene oxide (GO) aqueous dispersion to dilution with deionized water to obtain a diluted GO aqueous dispersion with a first preset concentration; and adding the dispersion of surface-treated carbon blacks varying in particle size to the diluted GO aqueous dispersion followed by ultrasonication at a preset power for a second preset time to obtain a GO/carbon blacks varying in particle size aqueous dispersion;
(3) adding deionized water to a latex of a NR for dispersion to obtain a NR dispersion with a second preset concentration; adding the GO/carbon blacks varying in particle size aqueous dispersion to the NR dispersion followed by mechanical stirring at a second preset speed for a third preset time to obtain a mixed emulsion; adding a flocculant to the mixed emulsion for flocculation to obtain a crude rubber; and subjecting the crude rubber to water washing, water removal, and drying to obtain a GO/carbon blacks varying in particle size modified NR masterbatch;
(4) subjecting the GO/carbon blacks varying in particle size modified NR masterbatch to internal mixing at a first preset temperature in an internal mixer; sequentially adding an anti-aging agent, an antioxidant, and a vulcanization accelerator to the GO/carbon blacks varying in particle size modified NR masterbatch followed by the internal mixing, and adding an activator and a softener to the GO/carbon blacks varying in particle size modified NR masterbatch followed by the internal mixing for dispersion to obtain a first rubber compound; and
cooling the first rubber compound to room temperature followed by open milling on two rolls of an open mill at a second preset temperature for a fourth preset time, and adding a vulcanizing agent followed by mixing and mill run until there are no bubbles in the first rubber compound; and allowing the first rubber compound to stand for a fifth preset time, so as to obtain a second rubber compound, wherein the second rubber compound is a graphene/carbon blacks varying in particle size synergistically modified NR compound, a weight ratio of the NR in the second rubber compound to the anti-aging agent to the antioxidant to the vulcanization accelerator to the activator to the softener to the vulcanizing agent is 100:1:1:1:5:2:3; and the vulcanization accelerator is N-cyclohexylbenzothiazole-2-sulphenamide, and the vulcanizing agent is sulfur; and
(5) placing the second rubber compound into a mold followed by vulcanization under a preset pressure at a third preset temperature for a sixth preset time, so as to obtain the heavy-duty tire.

In some embodiments, in step (1), the first preset speed is 400-6,000 rpm, and the first preset time is 30-50 min.

In some embodiments, in step (2), the first preset concentration of the diluted GO aqueous dispersion is 2-6 mg/mL, the preset power is 100-300 W, and the second preset time is 15-20 min.

In some embodiments, in step (3), the second preset concentration of the NR dispersion is 10-30 wt. %.

In some embodiments, in step (3), the second preset speed is 400-700 rpm, and the third preset time is 10-30 min.

In some embodiments, in step (3), the GO/carbon blacks varying in particle size modified NR masterbatch has a GO content of 0.28 wt. % and a carbon black content of 44.3 wt. %.

In some embodiments, in step (4), the first preset temperature is 110-120° C.; the second preset temperature is 50-80° C., a rotation speed of the two rolls is 12-20 rpm, and the fourth preset time is 6-15 min; and the fifth preset time is 20-30 h.

In some embodiments, in step (5), the preset pressure is 10-20 MPa, the third preset temperature is 140-160° C., and the sixth preset time is 5-20 min.

Compared to the prior art, the present disclosure has the following beneficial effects.

(1) The present disclosure utilizes a method of compounding graphene with carbon blacks varying in particle size to prepare a modified NR composite for a heavy-duty tire. This can improve the dispersion of reinforcing fillers within the rubber matrix, and concurrently increases the hardness and mechanical properties of the rubber while imparting the formed rubber composite with a lower compression heat generation value during motion. This leads to mitigated aging failure and extended service life of the heavy-duty tire, which meets application requirements for heavy-duty tires, so as to provide new insights into the application of graphene/carbon blacks varying in particle size synergistically modified NR composites in heavy-duty tires.

(2) The present disclosure adopts regulation of the crosslinked network structure of the rubber by adjusting the ratio of vulcanizing agent to accelerator, which leads to superior mechanical properties on the basis of improving the heat generation and hardness of the rubber, thereby further enhancing the service life of the NR heavy-duty tire.

(3) Compared to other tire preparation processes, the present disclosure employs an efficient and industrially practical aqueous-phase synergistic aggregating precipitating process to prepare a GO/carbon blacks varying in particle size modified NR masterbatch with excellent dispersion. Furthermore, a GO/carbon blacks varying in particle size and vulcanization system synergistically modified NR compound is prepared by means of mechanical blending. Finally, the heavy-duty tire is prepared from the graphene/carbon blacks varying in particle size synergistically vulcanized modified NR through a molding process. Each of the aforementioned steps can be accomplished using conventional processes, thereby facilitating industrial-scale production.

(4) The materials involved in preparing the graphene/carbon blacks varying in particle size synergistically modified NR according to the present disclosure are environmentally friendly and low-cost. Furthermore, this process results in continuous production and simple operation of the instrumentation and equipment, making it easy to achieve industrialized production.

### BRIEF DESCRIPTION OF THE DRAWINGS

The accompanying drawings, which are incorporated into and constitute a part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

FIGS. 1a-d are scanning electron microscope (SEM) images of N110, N330, N660, and N765 carbon blacks used in Examples 1-3 and Comparative Examples 1˜4 of the present disclosure as reinforcing fillers;

FIGS. 2a-b show particle size and distribution of the N110, N330, N660, and N765 carbon blacks used in Examples 1-3 and Comparative Examples 1˜4 of the present disclosure measured by Zeta potential particle size analyzer;

FIG. 3a shows a thermogravimetric curve of carbon black before and after modification in Example 3 of the present disclosure;

FIG. 3b shows Raman spectra of the carbon black before and after modification in Example 3 of the present disclosure; and

FIG. 4 shows crosslinking density of a graphene/carbon blacks varying in particle size synergistically vulcanized modified NR prepared in Example 3 and Comparative Examples 3-4 of the present disclosure.

### DETAILED DESCRIPTION OF EMBODIMENTS

In order to understand the above objects, features and beneficial effects of the present disclosure more clearly, the technical solutions of the present disclosure will be further described below. It should be noted that, as long as there is no contradiction, the embodiments of the present disclosure and the features in the embodiments can be combined with each other.

Many specific details are set forth in the following description to facilitate the understanding of the present disclosure, but the present disclosure can also be implemented in other ways different from those described herein. Obviously, described herein are merely some embodiments of the present disclosure, rather than all embodiments.

A method for preparing a heavy-duty tire with a natural rubber (NR) modified by graphene/carbon blacks varying in particle size synergized with a vulcanization system is provided herein, which includes the following steps.

Step (1), Water, a disodium methylene bisnaphthalene sulphonate, a sodium alkylnaphthalene sulfonate, KOH, and a casein are sequentially added into a high-speed mixer under stirring. After complete dissolution, a quartz sand is added to the mixer. Then, carbon blacks varying in particle sizes are added into the mixer and stirred at a first preset speed for a first preset time to obtain a dispersion of surface-treated carbon blacks varying in particle sizes.

Step (2), A graphene oxide (GO) aqueous dispersion is subjected to dilution with deionized water to obtain a diluted GO aqueous dispersion with a first preset concentration. Then, the dispersion of surface-treated carbon blacks varying in particle size is added to the diluted GO aqueous dispersion and ultrasonicated at a preset power for a second preset time to obtain a GO/carbon blacks varying in particle size aqueous dispersion.

Step (3), Deionized water is added to a latex of a NR for dispersion to obtain a NR dispersion with a second preset concentration. Then, the GO/carbon blacks varying in particle size aqueous dispersion is added to the NR dispersion, and mechanically stirred at a second preset speed for a third preset time to obtain a mixed emulsion. Subsequently, a flocculant is added to the mixed emulsion for flocculation to obtain a crude rubber. The crude rubber is subjected to water washing, water removal, and drying to obtain a GO/carbon blacks varying in particle size modified NR masterbatch.

Step (4), The GO/carbon blacks varying in particle size modified NR masterbatch is subjected to internal mixing at a first preset temperature in an internal mixer. An anti-aging agent, an antioxidant, and a vulcanization accelerator are sequentially added to the GO/carbon blacks varying in particle size modified NR masterbatch, and the internal mixing is continuously performed. Then, an activator and a softener are added, and the internal mixing is further continuously performed, so as to obtain a first rubber compound. After uniform mixing, the first rubber compound is discharged, cooled to room temperature, and then subjected to open milling on two rolls of an open mill at a second preset temperature for a fourth preset time. A vulcanizing agent is added, mixed uniformly, and then subjected to mill run until there are no bubbles in the first rubber compound, where the vulcanizing agent is sulfur. The first rubber compound is allowed to stand for a fifth preset time to obtain a second rubber compound, where second rubber compound is a graphene/carbon blacks varying in particle size synergistically modified NR compound.

Step (5), The second rubber compound is placed into a mold, and subjected to vulcanization under a preset pressure at a third preset temperature for a sixth preset time, so as to obtain the heavy-duty tire.

In an embodiment, in step (1), a weight ratio of the water to the disodium methylene bisnaphthalene sulphonate to the sodium alkylnaphthalene sulfonate to the KOH to the casein to the quartz sand to the carbon blacks is 720:1:0.5:1.5:3:150:80.

In the present disclosure, the carbon blacks include N330 carbon black, N110 carbon black, N660 carbon black, and N765 carbon black. A weight ratio of the N330 carbon black to the N110 carbon black to the N660 carbon black to the N765 carbon black is 3:0-1:0-1:0-1, where the N110 carbon black, the N660 carbon black, and the N765 carbon black are not simultaneously 0. In the present disclosure, the carbon blacks varying in particle size are primarily the N330 carbon black and compounded with the N110 carbon black, the N660 carbon black, and the N765 carbon black. Specifically, the carbon blacks with different particle sizes are a mixture of the N330 carbon black and at least one of the N110 carbon black, the N660 carbon black, and the N765 carbon black.

In an embodiment, in step (1), the first preset speed is 400-6,000 rpm, and the first preset time is 30-50 min.

In an embodiment, in step (2), the first preset concentration of the diluted GO aqueous dispersion is 2-6 mg/mL, the preset power is 100-300 W, and the second preset time for 15-20 min.

In an embodiment, in step (3), the second preset concentration of the NR dispersion is 10-30 wt. %.

In an embodiment, in step (3), the second preset speed is 400-700 rpm, and the third preset time is 10-30 min. In this embodiment, the flocculant is calcium chloride with a concentration of 5-10 wt. %.

In an embodiment, in step (3), the GO/carbon blacks varying in particle size modified NR masterbatch has a GO content of 0.28 wt. % and a carbon black content of 44.3 wt. %.

In an embodiment, in step (4), a weight ratio of the NR to the anti-aging agent to the antioxidant to the vulcanization accelerator to the activator to the softener to the vulcanizing agent is 100:1:1:1:5:2:3. The first preset temperature is 110-120° C., the internal mixing is performed for 5 min, the continuous internal mixing after addition of the anti-aging agent, the antioxidant and the vulcanization accelerator is performed for 5 min. The open milling is performed at 50-80° C. for 6-15 min, and a rotation speed of the two rolls is 12-20 rpm. The fifth preset time is 20-30 h.

In an embodiment, in step (5), the vulcanization is performed under 10-20 MPa at 140-160° C. for 5-20 min.

The specific embodiments of the present disclosure are described in detail below.

### Example 1

Provided herein was a method for preparing a heavy-duty tire with a natural rubber (NR) modified by graphene/carbon blacks varying in particle size synergized with a vulcanization system, which included the following steps.

Step (1), 720 g of deionized water was added into a high-speed mixer, and 1 g of disodium methylene bisnaphthalene sulphonate, 0.5 g of sodium alkylnaphthalene sulfonate, 1.5 g of KOH, and 3 g of casein were sequentially added into the mixer under stirring. After complete dissolution, 150 g of quartz sand was added, then 60 g of N330 carbon black and 20 g of N110 carbon black were respectively added, and stirred at 4,000 rpm for 30 min to obtain a dispersion of surface-treated carbon blacks varying in particle sizes.

Step (2), 50 g of a 10 mg/mL GO aqueous dispersion was subjected to dilution with deionized water to obtain a 2 mg/mL diluted GO aqueous dispersion. Then, the dispersion of surface-treated carbon blacks varying in particle size was added to the diluted GO aqueous dispersion and ultrasonicated at 100 W for 15 min to obtain a 76.6 mg/mL uniform GO/carbon blacks varying in particle size aqueous dispersion.

Step (3), 166.7 g of a NR latex with a solid content of 60 wt. % was subjected to dilution with deionized water to obtain a diluted NR dispersion with a solid content of 30 wt. %. Then, the GO/carbon blacks varying in particle size aqueous dispersion was added to the diluted NR dispersion and mechanically stirred at 400 rpm for 10 min. After thorough mixing, a uniformly dispersed mixed emulsion was obtained. 120 g of a 5 wt. % CaCl₂) aqueous solution was added to the mixed solution for flocculation to obtain a crude rubber. The crude rubber was subjected to water washing, water removal, and drying to obtain a GO/carbon blacks varying in particle size modified NR masterbatch having a GO content of 0.28 wt. % and a carbon black content of 44.3 wt. %.

Step (4), The GO/carbon blacks varying in particle size modified NR masterbatch was subjected to internal mixing at 110° C. for 5 min in an internal mixer. 1 g of 2,2,4-trimethyl-1,2-dihydroquinoline polymer (RD) as an anti-aging agent, 1 g of N-isopropyl-N′-phenyl-p-phenylenediamine (4010NA) as an antioxidant and 1 g of N-cyclohexylbenzothiazole-2-sulphenamide (CZ) as a vulcanization accelerator were added sequentially in batches, and the internal mixing was continued for 5 min. Then, 5 g of ZnO as an activator and 2 g of stearic acid (SA) as a softener were added, and the internal mixing was continued for a further 5 min to obtain a rubber compound. After uniform mixing, the rubber compound was discharged and cooled to room temperature. The rubber compound was subjected to open milling on two rolls of an open mill at 50° C. for 3 min. Then 3 g of sulfur(S) was added as a vulcanizing agent, and the open milling was continued for 3 min. After thorough mixing, the compound was subjected to mill run until free of bubbles and stored for 20 h, so as to obtain a graphene/carbon blacks varying in particle size synergistically modified NR compound.

Step (5), The graphene/carbon blacks varying in particle size synergistically modified NR compound was placed into a mold and vulcanized under 10 MPa at 140° C. for 20 min to obtain the heavy-duty tire.

### Example 2

Provided herein was a method for preparing a heavy-duty tire with a natural rubber (NR) modified by graphene/carbon blacks varying in particle size synergized with a vulcanization system, which included the following steps.

Step (1), 720 g of deionized water was added into a high-speed mixer, and 1 g of disodium methylene bisnaphthalene sulphonate, 0.5 g of sodium alkylnaphthalene sulfonate, 1.5 g of KOH, and 3 g of casein were sequentially added into the mixer under stirring. After complete dissolution, 150 g of quartz sand was added, then 60 g of N330 carbon black and 20 g of N660 carbon black were respectively added, and stirred at 5,000 rpm for 40 min to obtain a dispersion of surface-treated carbon blacks varying in particle sizes.

Step (2), 50 g of a 10 mg/mL GO aqueous dispersion was subjected to dilution with deionized water to obtain a 4 mg/mL diluted GO aqueous dispersion. Then, the dispersion of surface-treated carbon blacks varying in particle size was added to the diluted GO aqueous dispersion and ultrasonicated at 200 W for 15 min to obtain an 86.5 mg/mL uniform GO/carbon blacks varying in particle size aqueous dispersion.

Step (3), 166.7 g of a NR latex with a solid content of 60 wt. % was subjected to dilution with deionized water to obtain a diluted NR dispersion with a solid content of 40 wt. %. Then, the GO/carbon blacks varying in particle size aqueous dispersion was added to the diluted NR dispersion and mechanically stirred at 600 rpm for 20 min. After thorough mixing, a uniformly dispersed mixed emulsion was obtained. 80 g of a 7.5 wt. % CaCl₂) aqueous solution was added to the mixed solution for flocculation to obtain a crude rubber. The crude rubber was subjected to water washing, water removal, and drying to obtain a GO/carbon blacks varying in particle size modified NR masterbatch.

Step (4), The GO/carbon blacks varying in particle size modified NR masterbatch was subjected to internal mixing at 115° C. for 5 min in an internal mixer. 1 g of RD as an anti-aging agent, 1 g of 4010NA as an antioxidant and 1 g of CZ as a vulcanization accelerator were added sequentially in batches, and the internal mixing was continued for 5 min. Then, 5 g of ZnO as an activator and 2 g of SA as a softener were added, and the internal mixing was continued for a further 5 min to obtain a rubber compound. After uniform mixing, the rubber compound was discharged and cooled to room temperature. The rubber compound was subjected to open milling on two rolls of an open mill at 60° C. for 5 min. Then 3 g of sulfur was added as a vulcanizing agent, and the open milling was continued for 3 min. After thorough mixing, the compound was subjected to mill run until free of bubbles and stored for 20 h, so as to obtain a graphene/carbon blacks varying in particle size synergistically modified NR compound.

Step (5), The graphene/carbon blacks varying in particle size synergistically modified NR compound was placed into a mold and vulcanized under 15 MPa at 150° C. for 10 min to obtain the heavy-duty tire.

### Example 3

Provided herein was a method for preparing a heavy-duty tire with a natural rubber (NR) modified by graphene/carbon blacks varying in particle size synergized with a vulcanization system, which included the following steps.

Step (1), 720 g of deionized water was added into a high-speed mixer, and 1 g of disodium methylene bisnaphthalene sulphonate, 0.5 g of sodium alkyl naphthalene sulfonate, 1.5 g of KOH, and 3 g of casein were sequentially added into the mixer under stirring. After complete dissolution, 150 g of quartz sand was added, then 60 g of N330 carbon black and 20 g of N765 carbon black were respectively added, and stirred at 6,000 rpm for 50 min to obtain a dispersion of surface-treated carbon blacks varying in particle sizes.

Step (2), 50 g of a 10 mg/mL GO aqueous dispersion was subjected to dilution with deionized water to obtain a 6 mg/mL diluted GO aqueous dispersion. Then, the dispersion of surface-treated carbon blacks varying in particle size was added to the diluted GO aqueous dispersion and ultrasonicated at 300 W for 20 min to obtain a 91.1 mg/mL uniform GO/carbon blacks varying in particle size aqueous dispersion.

Step (3), 166.7 g of a NR latex with a solid content of 60 wt. % was subjected to dilution with deionized water to obtain a diluted NR dispersion with a solid content of 50 wt. %. Then, the GO/carbon blacks varying in particle size aqueous dispersion was added to the diluted NR dispersion and mechanically stirred at 700 rpm for 30 min. After thorough mixing, a uniformly dispersed mixed emulsion was obtained. 60 g of a 10 wt. % CaCl₂) aqueous solution was added to the mixed solution for flocculation to obtain a crude rubber. The crude rubber was subjected to water washing, water removal, and drying to obtain a GO/carbon blacks varying in particle size modified NR masterbatch.

Step (4), The GO/carbon blacks varying in particle size modified NR masterbatch was subjected to internal mixing at 120° C. for 5 min in an internal mixer. 1 g of RD as an anti-aging agent, 1 g of 4010NA as an antioxidant and 1 g of CZ as a vulcanization accelerator were added sequentially in batches, and the internal mixing was continued for 5 min. Then, 5 g of ZnO as an activator and 2 g of SA as a softener were added, and the internal mixing was continued for a further 5 min to obtain a rubber compound. After uniform mixing, the rubber compound was discharged and cooled to room temperature. The rubber compound was subjected to open milling on two rolls of an open mill at 80° C. for 7.5 min. Then 3 g of sulfur was added as a vulcanizing agent, and the open milling was continued for 3 min. After thorough mixing, the compound was subjected to mill run until free of bubbles and stored for 20 h, so as to obtain a graphene/carbon blacks varying in particle size synergistically modified NR compound.

Step (5), The graphene/carbon blacks varying in particle size synergistically modified NR compound was placed into a mold and vulcanized under 20 MPa at 160° C. for 5 min to obtain the heavy-duty tire.

### Comparative Example 1

Provided herein was a method for preparing a heavy-duty tire with a NR modified by graphene/N330 carbon black synergized with a vulcanization system with steps basically the same as those in Example 3, except that in step (1), 60 g of N330 carbon black and 20 g of N765 carbon black of Example 3 were replaced with 80 g of N330 carbon black.

### Comparative Example 2

Provided herein was a method for preparing a heavy-duty tire with a natural rubber (NR) modified by graphene/carbon blacks varying in particle size, which included the following steps.

Step (1), 50 g of a 10 mg/mL GO aqueous dispersion was subjected to dilution with deionized water to obtain a 6 mg/mL diluted GO aqueous dispersion.

Step (2), 166.7 g of a NR latex with a solid content of 60 wt. % was subjected to dilution with deionized water to obtain a diluted NR dispersion with a solid content of 50 wt. %. Then, the diluted GO aqueous dispersion was added to the diluted NR dispersion and mechanically stirred at 700 rpm for 30 min. After thorough mixing, a uniformly dispersed mixed emulsion was obtained. 60 g of a 10 wt. % CaCl₂) aqueous solution was added to the mixed solution for flocculation to obtain a crude rubber. The crude rubber was subjected to water washing, water removal, and drying to obtain a GO modified NR masterbatch.

Step (3), The GO modified NR masterbatch was subjected to internal mixing at 120° C. for 5 min in an internal mixer. 1 g of RD as an anti-aging agent, 1 g of 4010NA as an antioxidant and 1 g of CZ as a vulcanization accelerator were added sequentially in batches, and the internal mixing was continued for 5 min. Then, 5 g of ZnO as an activator, 2 g of SA as a softener and 60 g of N330 carbon black were added, and the internal mixing was continued for a further 2.5 min. Then, 20 g of N765 carbon black were added, and the internal mixing was continued for a further 2.5 min to obtain a rubber compound. After uniform mixing, the rubber compound was discharged and cooled to room temperature. The rubber compound was subjected to open milling on two rolls of an open mill at 80° C. for 7.5 min. Then 3 g of sulfur was added as a vulcanizing agent, and the open milling was continued for 3 min. After thorough mixing, the compound was subjected to mill run until free of bubbles and stored for 20 h, so as to obtain a graphene/carbon blacks varying in particle size synergistically modified NR compound.

Step (4), The graphene/carbon blacks varying in particle size synergistically modified NR compound was placed into a mold and vulcanized under 20 MPa at 160° C. for 5 min to obtain the heavy-duty tire.

### Comparative Example 3

The preparation method provided herein was basically the same as that in Example 3, except that in step (4), 2 g of the vulcanization accelerator CZ and 2 g of the vulcanizing agent S were added.

### Comparative Example 4

The preparation method provided herein was basically the same as that in Example 3, except that in step (4), 3 g of the vulcanization accelerator CZ and 1 g of the vulcanizing agent S were added.

Table 1 shows formulation of Examples 1-3 and Comparative Examples 1-4. The performance test results for Examples 1-3 and Comparative Examples 1-2 are shown in Table 2. The performance test results for Example 3 and Comparative Examples 3-4 are shown in Table 3.

TABLE 1
Formulation of Examples 1-3 and Comparative Examples 1-4

| | N110 | N330 | N660 | N765 | | Vulca- |
|---|---|---|---|---|---|---|
| | carbon | carbon | carbon | carbon | | nization |
| Examples | black/g | black/g | black/g | black/g | Sulfur/g | accelerator/g |
| Example 1 | 20 | 60 | — | — | 3 | 1 |
| Example 2 | — | 60 | 20 | — | 3 | 1 |
| Example 3 | — | 60 | — | 20 | 3 | 1 |
| Compar- | — | 80 | — | — | 3 | 1 |
| ative | | | | | | |
| Example 1 | | | | | | |
| Compar- | — | 60 | — | 20 | 3 | 1 |
| ative | | | | | | |
| Example 2 | | | | | | |
| Compar- | — | 60 | — | 20 | 2 | 2 |
| ative | | | | | | |
| Example 3 | | | | | | |
| Compar- | — | 60 | — | 20 | 1 | 3 |
| ative | | | | | | |
| Example 4 | | | | | | |

Samples were taken from the tires prepared in Examples 1-3 and Comparative Examples 1-4, and hardness, heat generation, mechanical properties, abrasion resistance, and permanent set properties of the modified NR composites were tested. The mechanical properties were tested according to ISO 37:2005, with a tensile speed of 500 mm/min and a tear speed of 500 mm/min. The heat generation performance was tested according to ISO 4666. The hardness was tested according to ISO 7619-1:2004. The abrasion resistance and permanent set properties were tested according to GB/T 9867:2008.

TABLE 2
Properties of graphene/carbon blacks varying in
particle size synergistically vulcanized modified
NR composites of the present disclosure

| | | | | Compar- | Compar- |
|---|---|---|---|---|---|
| | Exam- | Exam- | Exam- | ative | ative |
| | ple 1 | ple 2 | ple 3 | Example 1 | Example 2 |
| Hardness/HA | 80.5 | 79.5 | 81.0 | 79.0 | 78.5 |
| Heat generation | 31.9 | 28.9 | 27.5 | 33.1 | 32.5 |
| value/° C. | | | | | |
| Tear | 47.0 | 40.3 | 47.1 | 38.6 | 38.3 |
| strength/ | | | | | |
| (N/mm) | | | | | |
| Tensile | 22.3 | 21.7 | 23.2 | 21.4 | 19.5 |
| strength/MPa | | | | | |
| Breaking | 236.9 | 230.5 | 272.1 | 229.8 | 225.4 |
| elongation/% | | | | | |
| 100% elongation | 8.3 | 8.1 | 7.2 | 8.4 | 7.0 |
| modulus | | | | | |
| (M100)/MPa | | | | | |
| 200% elongation | 19.3 | 19.0 | 17.5 | 19.2 | 18.0 |
| modulus | | | | | |
| (M200)/MPa | | | | | |
| Thermal | 0.38 | 0.37 | 0.39 | 0.36 | 0.35 |
| conductivity/ | | | | | |
| (W/m · k) | | | | | |
| Abrasion | 44.0 | 51.0 | 49.0 | 52.3 | 48.0 |
| loss/(mm³) | | | | | |
| Permanent | 2.44 | 2.89 | 2.75 | 2.87 | 2.63 |
| deformation/% | | | | | |

It can be seen from Table 2 that the graphene/carbon blacks varying in particle size synergistically vulcanized modified NR composites prepared by the aqueous-phase synergistic aggregating precipitating process of the present disclosure exhibit high hardness, low heat generation value, and excellent mechanical properties. It can also be seen from Table 2 that the hardness of the graphene/carbon blacks varying in particle size synergistically vulcanized modified NR composites prepared by blending carbon blacks varying in particle size according to the present disclosure meets engineering application requirements for heavy-duty tires, while the heat generation value is significantly reduced. Moreover, the mechanical properties are significantly superior to those of GO/carbon black modified natural rubber composites prepared using a single type of carbon black. This fully demonstrates that the method of blending the carbon blacks varying in particle size as the reinforcing filler of the present disclosure has advantages in significantly increasing the hardness and reducing the heat generation value of the prepared rubber composites.

TABLE 3
Properties of graphene/carbon blacks varying in
particle size synergistically vulcanized modified
NR composites of the present disclosure

| | | Comparative | Comparative |
|---|---|---|---|
| | Example 3 | Example 3 | Example 4 |
| Hardness/HA | 81.0 | 78.5 | 74.0 |
| Heat generation | 27.5 | 28.0 | 29.3 |
| value/° C. | | | |
| Tear | 47.1 | 42.5 | 36.3 |
| strength/ | | | |
| (N/mm) | | | |
| Tensile | 23.2 | 21.8 | 16.5 |
| strength/MPa | | | |
| Breaking | 272.1 | 265.4 | 288.6 |
| elongation/% | | | |
| M100/MPa | 7.2 | 7.5 | 6.2 |
| M200/MPa | 17.5 | 18.0 | 13.4 |
| Thermal | 0.39 | 0.37 | 0.38 |
| conductivity/ | | | |
| (W/m · k) | | | |
| Abrasion | 49.0 | 53.4 | 59.6 |
| loss/(mm³) | | | |
| Permanent | 2.75 | 2.94 | 3.05 |
| deformation/% | | | |

It can be seen from Table 3 that by adjusting the ratio of the vulcanizing agent to the vulcanization accelerator, the cross-linked network structure of the rubber can be effectively regulated, thereby resulting in excellent mechanical properties of the graphene/carbon blacks varying in particle size synergistically vulcanized modified NR and heavy-duty tire prepared therefrom on the basis of improvement of the heat generation value and hardness of the rubber product, thus further improving the service life of the formed heavy-duty tire.

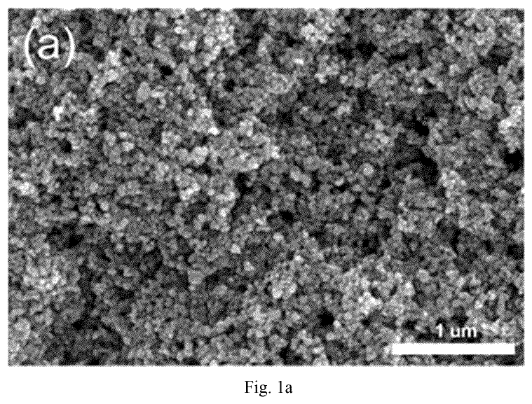

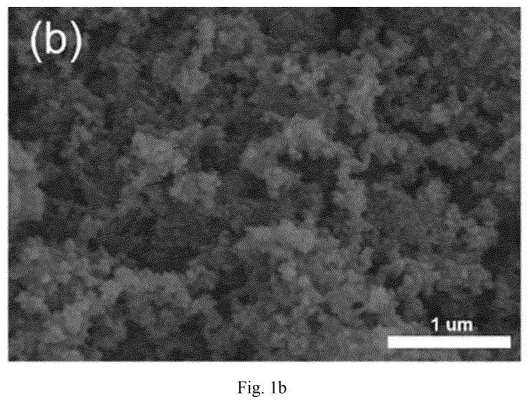

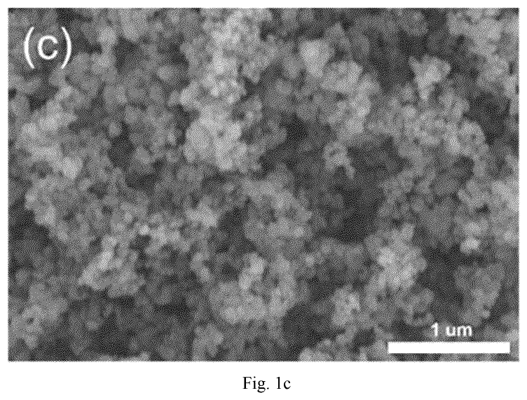

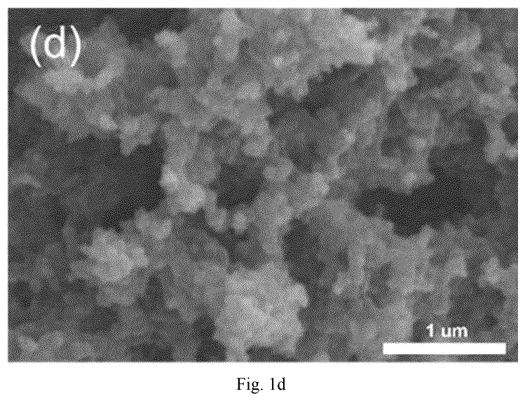

As shown in FIGS. 1a-d, regarding particle size, FIG. 1a shows that the N110 carbon black has the smallest particle size, and its primary particles exhibit an ellipsoidal structure. The particle size continuously increases as the carbon black type changes from N110 to N765. FIG. 1d shows that compared with the other types of carbon black, the N765 carbon black has the largest particle size, and its primary particles have changed from the ellipsoidal structure of N110 to a flattened circular structure. This structure results in a greatly reduced surface area, thus reducing the contact area with rubber molecular chains when used as a reinforcing filler for NR. In terms of aggregate structure, carbon black primary particles aggregate to form branched-chain agglomerates. The carbon black particle size gradually increases, and the branched-chain structure of the carbon black changes from short and dense to long and sparse as the carbon black type changes from N110 to N765.

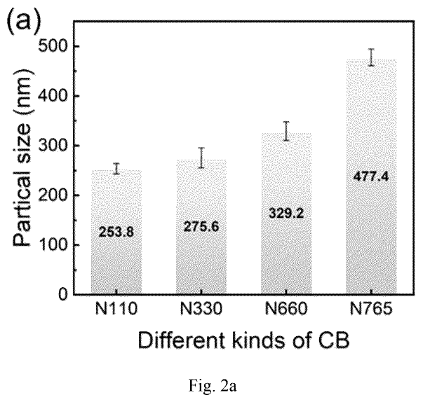

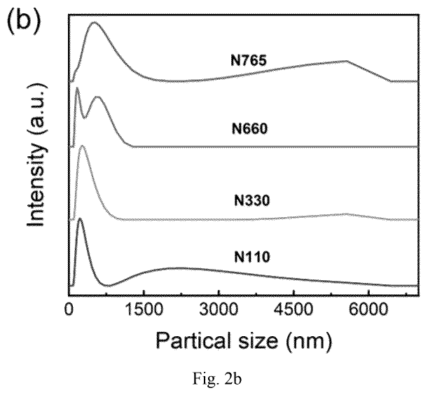

As shown in FIG. 2a, the average particle size of the N110 carbon black is 253.8 nm. As shown in FIG. 2b, the particle size of the N110 carbon black is mainly distributed around 250 nm, with a few agglomerates distributed near 2,500 nm, which indicates that the N110 type carbon black has a smaller particle size and shorter branched-chain structure. These characteristics can improve its dispersion in rubber composites. As shown in FIG. 2a, the average particle size of the N330 carbon black is 275.6 nm. As shown in FIG. 2b, the particle size of the N330 carbon black is mostly distributed around 300 nm. As shown in FIG. 2a, the average particle size of the N660 carbon black is 324.8 nm. As shown in FIG. 2b, the particle size of the N660 carbon black is distributed on average in two parts, near 186 nm and 557 nm, respectively. As shown in FIG. 2a, the N765 carbon black has the highest average particle size of 477.2 nm. As shown in FIG. 2b, the particle size of the N765 carbon black is mostly distributed around 526 nm, with the remaining part near 4,600 nm. Compared to other types of carbon black, the N765 carbon black has a wider particle size distribution, indicating that most of its primary particles are agglomerated and stacked together, forming longer branched-chain structures.

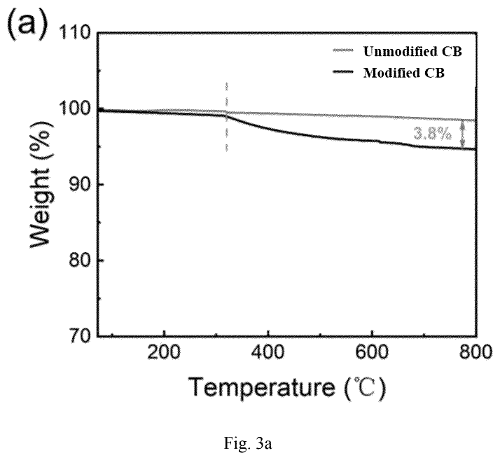

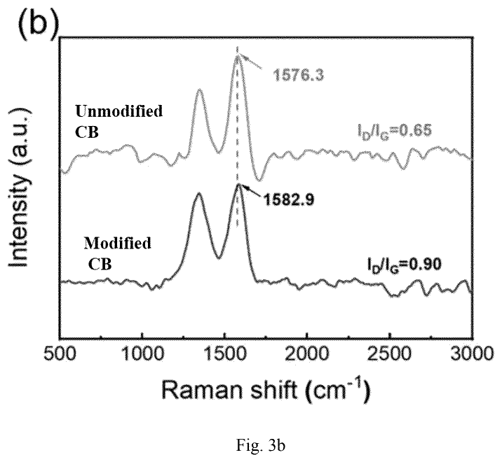

It can be seen from the Raman spectra in FIG. 3a that compared with unmodified carbon black, the ratio of intensity of D peak and G peak (I_{D}/I_{G}) of the modified carbon black increases from 0.65 to 0.90. The increase in the I_{D}/I_{G} ratio indicates that the carbon black surface is coated and adsorbed by the modifier, i.e., the disodium methylene bisnaphthalene sulphonate. The carbon structure introduced by the disodium methylene bisnaphthalene sulphonate differs from that of the carbon black, resulting in a decrease in the degree of order of the carbon black and a further increase in disordered carbon. FIG. 3b shows the thermogravimetric curves of unmodified carbon black and modified carbon black. It can be seen that the weight loss of the unmodified carbon black is relatively small and remains slow throughout the heating stage. The weight loss of the modified carbon black is due to the volatilization of bound water adsorbed on the carbon black surface upon heating at low temperatures. As the temperature increases, the weight loss of the modified carbon black gradually becomes greater than that of the unmodified carbon black after 320° C., proving that the modifier adsorbed on the carbon black surface gradually decomposes upon heating, indicating successful modification.

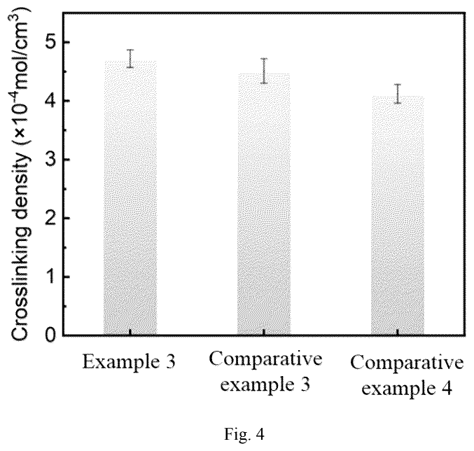

As shown in FIG. 4, by adjusting the ratio of the vulcanizing agent to the vulcanization accelerator, differences in the cross-linked network structure of the prepared rubber composites were caused. Compared with the modified rubber composites prepared in Comparative Examples 3 and 4, the graphene/carbon blacks varying in particle size synergistically vulcanized modified natural rubber composite prepared in Example 3 has the highest crosslinking density of 4.72×10-4 mol/cm3, proving that it has a well-developed cross-linked network, thus improving hardness and mechanical properties.

The embodiments described above are merely illustrative of the present application, and are intended to enable those skilled in the art to understand or implement the present disclosure, instead of limiting the scope of the present application. Although detailed descriptions have been made with reference to the above embodiments, modifications to the technical solutions recited in the above embodiments, or equivalent substitutions for some or all of the technical features made by those of ordinary skill in the art without departing from the spirit of the disclosure shall fall within the scope of the disclosure defined by the appended claims.

What is claimed is:

1. A method for preparing a heavy-duty tire with a natural rubber (NR) modified by graphene/carbon blacks varying in particle size synergized with a vulcanization system, comprising:
(1) sequentially adding water, a disodium methylene bisnaphthalene sulphonate, a sodium alkylnaphthalene sulfonate, KOH, and a casein into a mixer under stirring for dissolution; and after complete dissolution, sequentially adding a quartz sand and carbon blacks varying in particle size into the mixer followed by stirring at a first preset speed for a first preset time to obtain a dispersion of surface-treated carbon blacks varying in particle size;
wherein a weight ratio of the water to the disodium methylene bisnaphthalene sulphonate to the sodium alkylnaphthalene sulfonate to the KOH to the casein to the quartz sand to the carbon blacks is 720:1:0.5:1.5:3:150:80; the carbon blacks comprise N330 carbon black, N110 carbon black, N660 carbon black, and N765 carbon black; and a weight ratio of the N330 carbon black to the N110 carbon black to the N660 carbon black to the N765 carbon black is 3:0-1:0-1:0-1, wherein the N110 carbon black, the N660 carbon black, and the N765 carbon black are not simultaneously 0;
(2) subjecting a graphene oxide (GO) aqueous dispersion to dilution with deionized water to obtain a diluted GO aqueous dispersion with a first preset concentration; and adding the dispersion of surface-treated carbon blacks varying in particle size to the diluted GO aqueous dispersion followed by ultrasonication at a preset power for a second preset time to obtain a GO/carbon blacks varying in particle size aqueous dispersion;
(3) adding deionized water to a latex of a NR for dispersion to obtain an NR dispersion with a second preset concentration; adding the GO/carbon blacks varying in particle size aqueous dispersion to the NR dispersion followed by mechanical stirring at a second preset speed for a third preset time to obtain a mixed emulsion; adding a flocculant to the mixed emulsion for flocculation to obtain a crude rubber; and subjecting the crude rubber to water washing, water removal, and drying to obtain a GO/carbon blacks varying in particle size modified NR masterbatch;
(4) subjecting the GO/carbon blacks varying in particle size modified NR masterbatch to internal mixing at a first preset temperature in an internal mixer; sequentially adding an anti-aging agent, an antioxidant, and a vulcanization accelerator to the GO/carbon blacks varying in particle size modified NR masterbatch followed by the internal mixing, and adding an activator and a softener to the GO/carbon blacks varying in particle size modified NR masterbatch followed by the internal mixing for dispersion to obtain a first rubber compound; and
cooling the first rubber compound to room temperature followed by open milling on two rolls of an open mill at a second preset temperature for a fourth preset time, and adding a vulcanizing agent followed by mixing and mill run until there are no bubbles in the first rubber compound; and allowing the first rubber compound to stand for a fifth preset time, so as to obtain a second rubber compound;
wherein the second rubber compound is a graphene/carbon blacks varying in particle size synergistically modified NR compound; a weight ratio of the NR in the second rubber compound to the anti-aging agent to the antioxidant to the vulcanization accelerator to the activator to the softener to the vulcanizing agent is 100:1:1:1:5:2:3; and the vulcanization accelerator is N-cyclohexylbenzothiazole-2-sulphenamide, and the vulcanizing agent is sulfur; and
(5) placing the second rubber compound into a mold followed by vulcanization under a preset pressure at a third preset temperature for a sixth preset time, so as to obtain the heavy-duty tire.

2. The method of claim 1, wherein in step (1), the first preset speed is 400-6,000 rpm, and the first preset time is 30-50 min.

3. The method of claim 1, wherein in step (2), the first preset concentration of the diluted GO aqueous dispersion is 2-6 mg/mL, the preset power is 100-300 W, and the second preset time is 15-20 min.

4. The method of claim 1, wherein in step (3), the second preset concentration of the NR dispersion is 10-30 wt. %.

5. The method of claim 1, wherein in step (3), the second preset speed is 400-700 rpm, and the third preset time is 10-30 min.

6. The method of claim 1, wherein in step (3), the GO/carbon blacks varying in particle size modified NR masterbatch has a GO content of 0.28 wt. % and a carbon black content of 44.3 wt. %.

7. The method of claim 1, wherein in step (4), the first preset temperature is 110-120° C.; the second preset temperature is 50-80° C., a rotation speed of the two rolls is 12-20 rpm, and the fourth preset time is 6-15 min; and the fifth preset time is 20-30 h.

8. The method of claim 1, wherein in step (5), the preset pressure is 10-20 MPa, the third preset temperature is 140-160° C., and the sixth preset time is 5-20 min.
